(19) United States
(12) Patent Application Publication
(10) Pub. No.: US 2004/0185949 A1
(43) Pub. Date: Sep. 23, 2004

(54) Bird perch with rotating toy

(76) Inventor: Robert Lee Bromley, Parker, CO (US)

Correspondence Address: ROBERT LEE BROMLEY, 2911 W. LONG DR #E, LITTLETON, CO, 80120, US

(21) Appl. No.: 10/300,381

(22) Filed: Mar. 21, 2003

(51) Int. Cl. A63G 13/00

(52) U.S. Cl. 472/135

(57) ABSTRACT

An improved bird perch comprising a fixedly attached mounting member, and a pivoting means for a rotating member. The rotating member can have various shapes such as a formed planar track, a formed multi-planar track, and a formed helical track. The rotatable member can also be an enclosure such as a cage for having constrained objects within or coupled objects along its outer perimeter. The rotatable member is manipulated by the primary action of a bird causing secondary action of objects coupled to said rotating member by gravitational and bird manipulative action. The improved bird perch can accommodate one or more birds for stimulation and entertainment. The bird perch is not limited to mounting to a fixed surface but may also be free standing.

### BACKGROUND

1. Field of Invention:

This invention relates to a bird supporting member commonly referred to as a perch, an interconnected rotating member with at least one pivot attachment, and objects coupled to the rotating member so as to move when the rotating member is rotated.

2. Description of Prior Art

Prior art shows many types of bird supporting members and some toys, not for birds, that incorporate a three dimensional track with coupled objects. Supporting members, commonly known as a perch, are made of wood dowels or wood branches supported at one or both ends. A perch is typical of horizontal beam structures to provide bird support above the floor of a cage. Derivations have included cantilevered designs which are only attached to a cage at one end. While other perch designs are variable in diameter and shape. Other types of perch material have included reinforced rope with rigid rods in the center and others have a flexible core for manipulating the shape. These prior art perch devices do not provide entertainment for a bird, but do provide bird support when attached in a manner as to provide horizontal support.

While other prior art perches have entertainment value as well, such as a swinging perch that is suspended from the top of a cage by a rope, cord, or chain. Other perch designs incorporate a feeding dish suitable for feed or water, and may or may not include a mirror for a birds entertainment and or may or may not include a linear beam that does not rotate. Along the beam may be sliding beads for their entertainment. Typically this type of perch has no activity except for the incorporation of moving beads. The beads may rotate about the beam but the travel from one end of the beam to the other remains two dimensional. Such limited movement becomes uninteresting to a bird which must be challenged intellectually with variations in spatial position.

Other prior art methods include non-bird inventions. These inventions typically have a formed track, usually made of wire, with coupled objects, usually beads made from wood. The track is three dimensional but are not moveable or rotatable. These tracks are rigidly mounted to a fixed support. There is no interaction with the movement of tracks.

My invention provides a horizontal supporting beam to act as a perch with a pivoting means for a rotating member that is manipulated by a bird thereby causing a subsequent action of the coupled members to rotating member. By varying the shape of the rotating member many types of actions can be created for the interest of a bird. One method of my invention uses a wavy S shaped rotating member that acts as a track for the coupled members. The waviness of the track allows the coupled members to independently move up, down, or rotate on the track in a random manner influenced by gravity and by a bird's action causing movement of the rotating member.

### OBJECTS AND ADVANTAGES

Prior art of bird perches provide a supporting means to hold a bird above surfaces or objects. These perches provided little entertainment value for a bird. Other prior art shows formed track systems with coupled objects, but the tracks do not move, nor are they designed for birds. Accordingly several objects and advantages of my invention are:

Birds are curious problem solvers by nature. They like to investigate objects in a manner that suits their intelligence and destructiveness. They also become irritated when objects are rearranged in a manner that appears to occur against their will.

When objects are movable, birds try to manipulate the objects by rearranging or destroying them. If the movement is linear and two dimensional the birds become bored by the limited possibilities of movement. Typically a bird would select an object along the beam and try to remove it or slide it back and forth. This provides very limited movement, and limited stimulation for a bird.

One object of my invention is to have a non-linear track that can be formed into a variety of shapes that is planar or a variety of shapes that is multi-planar. This track would be pivotally mounted to the perch so as to rotate about it's pivot. The rotation would cause the subsequent movement of the coupled members along the track. The rotation of the track causes random groupings of the coupled members to vary based on the rotation angle and a birds interaction moving the coupled members about the track. The track rotation would cause different coupled members to be closer to a bird or farther away from a bird depending on their relative position along the track. The typical action for a bird is to select an object along the wavy track, at which time all the objects are at rest. Once a bird lifts the object along the track, the track will rotate, causing all of the other objects to begin movement. Many times this movement frustrates a bird into more activity, since a bird wanted only one object to move.

Another object of my invention is to have a rotating member that is similar to a small cylinder cage that can encapsulate objects within itself. The encapsulated objects are susceptible to the rotation of the cage. The beams that interconnect the end pieces can be semi-flexible so as to allow a bird to pull objects out of the cage with some effort. The beams can also be formed into but not limited to a helix. As a bird attempts to extract the object, the helical cage rotates changing the position of the object on the spiral track thereby causing the inner object to move transversly away from a bird. This involuntary action creates stimulation and an intellectual challenge for a bird.

My invention comprises of a bird supporting member made of materials but not limited to wood or plastic. Directly attached to a bird supporting member is a rotating member made of materials that can be formed into different shapes but not limited to wood, plastic, or metal. The objects that are coupled to the rotating member can be made of materials that can be formed into different shapes but not limited to wood, plastic, or metal.

Further objects and advantages of my invention will become apparent from the consideration of the drawings and ensuing descriptions.

### BRIEF DESCRIPTION OF DRAWINGS

FIG. 1 shows a perspective view of my invention depicting a one piece bird supporting member with a ‘U’ shaped rotating track member having coupled objects

FIG. 2 shows a perspective view of my invention depicting a first and second end piece connected by one or more bird supporting members with a rotating cage member encapsulating an inner object

FIG. 3 shows a perspective view of my invention depicting a cantilevered bird supporting member with a rotating track member having coupled objects

FIG. 4 shows a perspective view of my invention depicting a closed shape bird supporting member with a vertical mounting means, a rotating carousel member, and suspended members having coupled objects

While my above descriptions of the drawings contain specifics, these should not be construed as limitations on the scope or orientation of the invention, nor as a limitation to its applicable use for birds, but rather an exemplification of one preferred embodiment thereof. Many other variations are possible. For example this could be an educational toy for children providing spatial visualization that changes during the rotating action.

Accordingly the scope of the invention should be determined not by the embodiments illustrated but by the appended claims and their legal equivalents.

### REFERENCE NUMERALS IN DRAWINGS

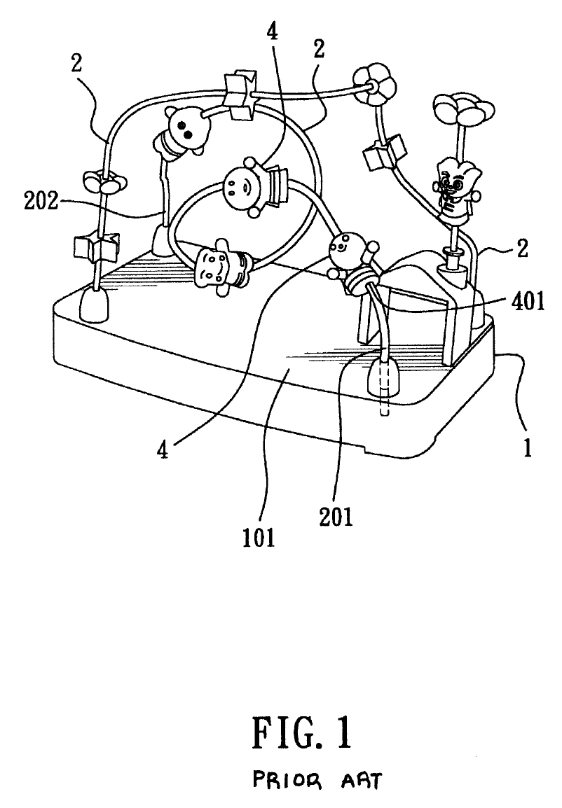

FIG. 1, 2, 3

1) pivot means

2) threaded mounting means

3) mounting reinforcement

4) mounting nut

FIG. 1

5) one piece bird supporting member

6) rotating track member

7) coupled object

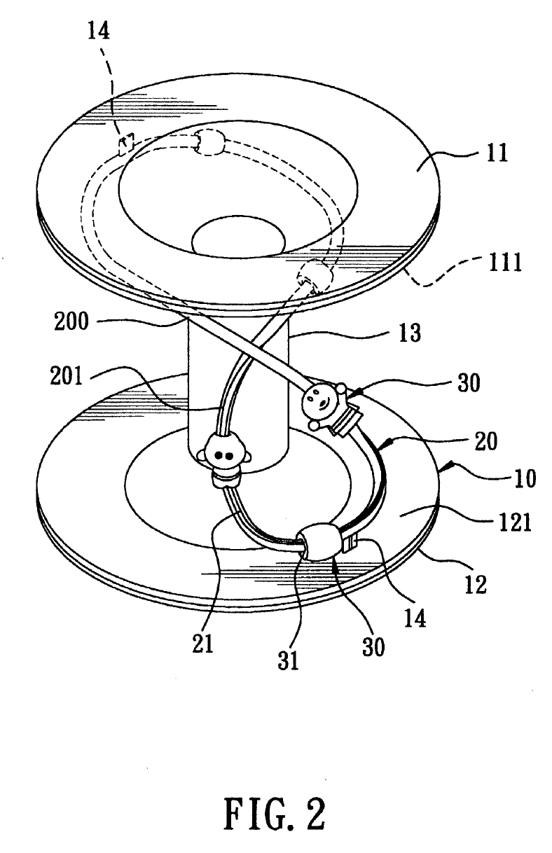

FIG. 2

50) bird supporting member

8) first end piece

9) connecting beam member

10) second end piece

11) third open end piece

12) fourth closed end piece

13) connecting beam members

14) inner object

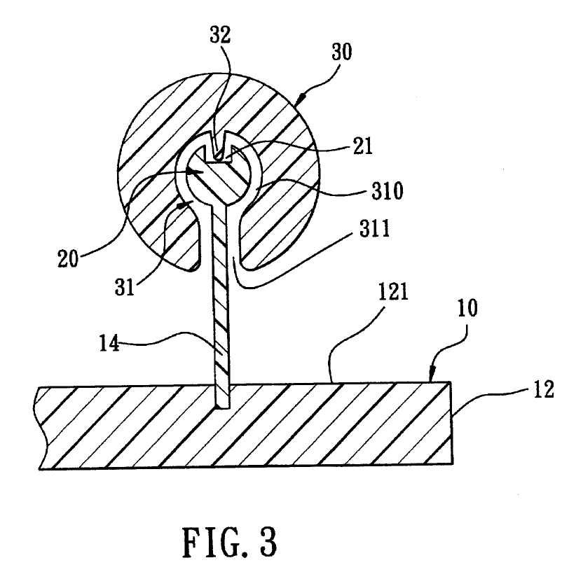

FIG. 3

15) cantilevered supporting member

16) rotating track member

17) coupled objects

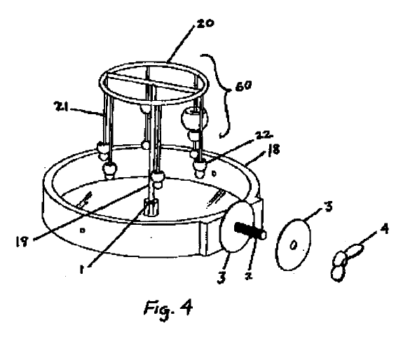

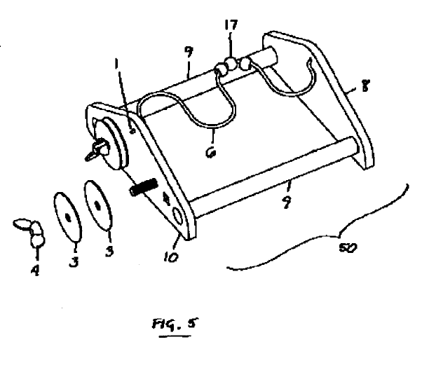

FIG. 4

18) closed shape supporting member

60) carousel system

19) vertical mounting means

20) rotating top member

21) suspending support member

22) coupled objects

### SUMMARY

My invention is a bird toy which consists of one or multiple bird supporting members with direct attachment of one or more rotating members that has movable coupled objects relatively constrained to a rotating member thereby creating multiple directional movements with more entertainment value for a bird.

### DESCRIPTION OF DRAWINGS FIGS. 1 TO 4

A bird supporting member with pivoting means

FIG. 1, shows a pivoting means 1, a mounting means comprising a threaded member 2, a mounting reinforcement 3, and a mounting nut 4, a bird supporting member 5, formed from a single material into an open shape, a rotating track member 6, and coupled objects 7.

FIG. 2, shows a pivoting means 1, a mounting means comprising a threaded member 2, a mounting reinforcement 3, and a mounting nut 4, a bird supporting member 50, comprising a first end piece 8, connecting bird support members 9, a second end piece 10, a rotating cage 60 comprising, a third open end piece 11, a fourth closed end piece 12, connecting beam members 13, and an inner object 14.

FIG. 3, shows a pivoting means 1, a mounting means comprising a threaded member 2, a mounting reinforcement 3, and a mounting nut 4, a bird supporting member 15, a rotating track member 16, and a coupled object 17.

FIG. 4, shows a pivoting means 1, a mounting means comprising a threaded member 2, a mounting reinforcement 3, and a mounting nut 4, a closed shape bird supporting member 18, a vertical mounting member 19, a rotating top 20, suspending members 21, and coupled objects 22.

### CONCLUSION

Thus the reader can see that a bird supporting member having a rotating member provides a variety of movements not currently found on prior art bird perches. The enhanced interaction comes from a rotating member that causes three dimensional position changes of the moving objects so as to provide dynamic movement and greater interest and entertainment for a bird.

While my above descriptions contain specifics, these should not be construed as limitations on the scope or orientation of the invention, nor as a limitation to its applicable use for birds, but rather an exemplification of one preferred embodiment thereof. many other variations are possible. For example this would be an educational toy for children teaching them spatial relationships which can change during the action and reaction of different three dimensional movements.

Accordingly the scope of the invention should be determined not by the embodiments illustrated, but by the appended claims and their legal equivalents.

### RAMIFICATIONS

The invention can be of various sizes to accommodate the sizes required for specific bird species and other use applications. Moving objects can be man made such as beads, odd shaped objects, pasta and the like, or natural objects such as nuts, fruit, and the like that would be of interest to a bird. The rotating member can be made of metal, plastic, wood, or any other shapeable material. The colors of any member can be specified to fit the appropriate use. A bird supporting member can be a single or multiple supporting members in order to suit its playfulness, shape, and accommodations for multiple birds to play at one time. Attachment of objects can be permanent or removable in order to suit various marketing and shipping requirements. The relationship of objects to the rotating member can be constrained along, constrained within, or coupled to the rotating member to provide various types of movements. The construction of the invention can be made as one piece or multiple pieces so as to facilitate reduction of costs in assembly. The invention can open within a shape or have a closed bottom. All of the various members and objects can be made to be destructible or non destructible to suit the various applications.

### SCOPE OF INVENTION

The description of this invention is not limited to the configurations shown but to encompass any variation that creates three dimension movement of coupled objects as a result two or more inter-related members with at least two independent movements. The invention is not limited to the use for birds, but could be used as an educational toy for children, or entertainment for other curious animals.

I claim:

1) a bird toy comprising
a beam member
with a pivoting means for a rotating member
said beam member having a mounting means to a fixed surface

2) a bird toy as in claim 1
having a rotating track member formed on a single plane
said rotating track member is suitable for guiding one or more coupled objects
said rotating track member having a mating connection for said pivoting means

3) a bird toy as in claim 1
having a rotating member comprising
a first end piece and second end piece
connected by one or more beams to form a rotatable cage
suitable for internally constrained and movable objects
said rotatable cage having a mating connection for said pivoting means

4) a bird toy as in claim 1
having a rotating member comprising
a first end piece and second end piece
connected by one or more beams to form a rotatable cage
with coupled objects along said beams
said rotatable cage having a mating connection for said pivoting means

5) a bird toy as in claim 1
having a rotating member comprising
a rotatable track member formed on more than one plane
suitable for one or more coupled objects
said rotating track member having a mating connection for said pivoting means

6) a bird toy as in claim 1
having a rotating member comprising
a rotatable track member formed in a helical shape
suitable for one or more coupled objects
said rotating track member having a mating connection for said pivoting means

7) a bird toy as in claim 1
having a vertical rotating member comprising
a vertical support member
a top member with a mating means to said vertical support member
with one or more suspended means suitable for one or more coupled objects
said vertical rotating member having a mating connection for said pivoting
means

8) a bird toy comprising
a one or more end pieces
having a pivoting means for a rotating member
said end pieces are connected together with one or more beams
one or more said end pieces having a mounting means to a fixed surface

9) a bird toy as in claim 8
having a rotating track member formed on a single plane
said rotating track member is suitable for guiding one or more coupled objects
said rotating track member having a mating connection for said pivoting means

10) a bird toy as in claim 8
having a rotating member comprising
a first end piece and second end piece
connected by one or more beams to form a rotatable cage
suitable for internally constrained and movable objects
said rotatable cage having a mating connection for said pivoting means

11) a bird toy as in claim 8
having a rotating member comprising
a first end piece and second end piece
connected by one or more beams to form a rotatable cage
with coupled objects along said beams
said rotatable cage having a mating connection for said pivoting means

12) a bird toy as in claim 8
having a rotating member comprising
a rotatable track member formed on more than one plane
suitable for one or more coupled objects
said rotating track member having a mating connection for said pivoting means

13) a bird toy as in claim 8
having a rotating member comprising
a rotatable track member formed in a helical shape
suitable for one or more coupled objects
said rotating track member having a mating connection for said pivoting means

14) a bird toy as in claim 8
having a vertical rotating member comprising
a vertical support member
a top member with a mating means to said vertical support member
with one or more suspended means suitable for one or more coupled objects
said vertical rotating member having a mating connection for said pivoting
means

15) a bird toy comprising
a beam member with a pivoting means for a rotating member
having a supporting vertical member
incorporating a base member for self standing stability

16) a bird toy as in claim 15
having a rotating track member formed on a single plane
said rotating track member is suitable for guiding one or more coupled objects
said rotating track member having a mating connection for said pivoting means

17) a bird toy as in claim 15
having a rotating member comprising
a first end piece and second end piece
connected by one or more beams to form a rotatable cage
suitable for internally constrained and movable objects
said rotatable cage having a mating connection for said pivoting means

18) a bird toy as in claim 15
having a rotating member comprising
a first end piece and second end piece
connected by one or more beams to form a rotatable cage
with coupled objects along said beams
said rotatable cage having a mating connection for said pivoting means

19) a bird toy as in claim 15
having a rotating member comprising
a rotatable track member formed on more than one plane
suitable for one or more coupled objects
said rotating track member having a mating connection for said pivoting means

20) a bird toy as in claim 15
having a rotating member comprising
a rotatable track member formed in a helical shape
suitable for one or more coupled objects
said rotating track member having a mating connection for said pivoting means

21) a bird toy as in claim 15
having a vertical rotating member comprising
a vertical support member
a top member with a mating means to said vertical support member
with one or more suspended means suitable for one or more coupled objects
said vertical rotating member having a mating connection for said pivoting
means
